(19) United States
(12) Patent Application Publication
(10) Pub. No.: US 2019/0216019 A1
(43) Pub. Date: Jul. 18, 2019

(54) Lawn sprinkler trimmer

(71) Applicants: Henry DeLaRosa, Campbell, CA (US); Michael Ure, Holladay, UT (US)

(72) Inventors: Henry DeLaRosa, Campbell, CA (US); Michael Ure, Holladay, UT (US)

(21) Appl. No.: 16/368,175

(22) Filed: Mar. 28, 2019

Related U.S. Application Data
(63) Continuation of application No. 14/949,626, filed on Nov. 23, 2015, now abandoned.

(51) Int. Cl. A01G 3/06

(52) U.S. Cl. CPC A01G 3/06

(57) ABSTRACT

A trimmer for trimming around a sprinkler head includes: an annular blade member defining an annular region inside the annular blade member, the annular blade member being sized so as to surround the sprinkler head in close proximity thereto; a support member coupled to the annular blade member without blocking an extended annular region extending upward from the annular region for a distance sufficient to accommodate a user's foot; and a handle coupled to the support member. The annular blade member and support member define a foot pressure surface. The annular blade member includes two opposing blades. Each of the two opposing blades includes two curved edges, the two curved edges meeting at a point of the blade.

### RELATED APPLICATIONS

This application is continuation of U.S. Ser. No. 14/535,820 filed Nov. 7, 2014, which is a continuation-in-part of U.S. Ser. No. 13/974,348 filed Aug. 23, 2013, which is a continuation-in-part of U.S. Ser. No. 29/426,178 filed Jul. 2, 2012.

### FIELD OF THE INVENTION

The present invention relates to lawn sprinkler head trimmers.

### BACKGROUND OF THE INVENTION

Trimming and edging around a conventional lawn sprinkler head is often a time-consuming and tedious task. The grass surrounding the sprinkler head is often thick and tends to grow over the sprinkler head. Constant edging is required to permit the sprinkler to operate properly. Often, turf overgrowth occurs. To expose sprinkler heads once turf overgrowth has occurred, string trimmers are often used. A common result, however, is excessive trimming, cratering, etc., producing an unsightly appearance. Over-trimming typically results in soil exposure and progressive erosion. In addition, damage to the sprinkler head can easily occur as a result of over-trimming.

A known sprinkler head trimmer is described in U.S. Pat. No. 6,311,782. Improvements to such a tool are described herein.

### BRIEF DESCRIPTION OF THE DRAWING FIGURES

The present invention may be further understood from the following Detailed Description in conjunction with the appended drawing figures. In the drawing:

FIG. 1 is a front view of a sprinkler head trimmer.

FIG. 2 is a partial view of the trimmer of FIG. 1.

FIG. 3 is a side view of the trimmer of FIG. 1.

FIG. 4 is a top view of the trimmer of FIG. 1.

FIG. 5 is a bottom view of the trimmer of FIG. 1.

FIG. 6A is a close-up view of a blade member of the trimmer of FIG. 1.

FIG. 6B is a close-up view of another blade member of a trimmer like that of FIG. 1.

FIG. 7 is a diagram of another embodiment of a trimmer.

FIG. 8 is a diagram of another embodiment of a trimmer.

### DETAILED DESCRIPTION

### Summary

A trimmer for trimming around a sprinkler head includes: an annular blade member defining an annular region inside the annular blade member, the annular blade member being sized so as to surround the sprinkler head in close proximity thereto; a support member coupled to the annular blade member without blocking an extended annular region extending upward from the annular region for a distance sufficient to accommodate a user's foot; and a handle coupled to the support member. The annular blade member and support member define a foot pressure surface. The annular blade member includes two opposing blades. Each of the two opposing blades includes two curved edges, the two curved edges meeting at a point of the blade. In one embodiment, parts of the trimmer not including the annular blade member are painted a distinctive color. The annular blade member may be stainless steel.

### Description

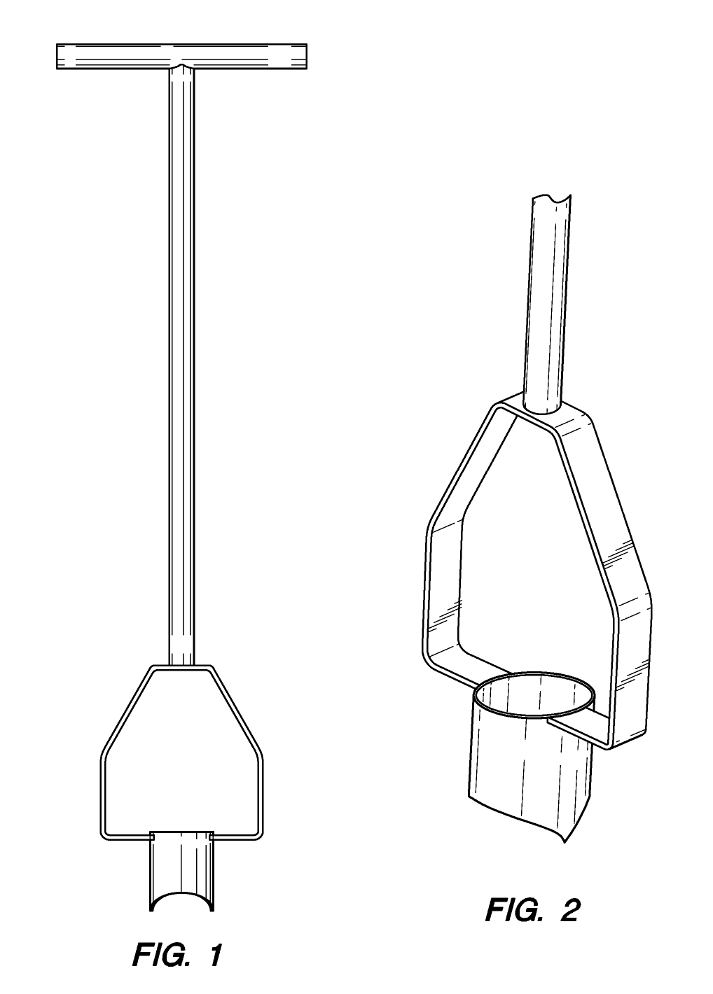

Referring to FIG. 1 and FIG. 2, diagrams are shown of a sprinkler head trimmer in accordance with one embodiment. A annular blade member (trimming head) 1 is supported by a support member 2, the trimming head 1 and the support member 2 together forming a foot pressure region 3. The support member 2 is joined to a T-shaped handle 5, which may be provided with grips. The T handle 5 may be formed of light-weight metal conduit. The support member 2 may be of a stirrup shape and formed of mild steel. The trimming head, in one embodiment, may be formed from a pipe section or tube section, and may be steel, stainless steel, etc. In other embodiments, to be further described below, the trimming head 1 may be formed of durable plastic (such as glass-filled nylon). In some embodiments, the support member 2 may also be formed of plastic, as may the T handle 5.

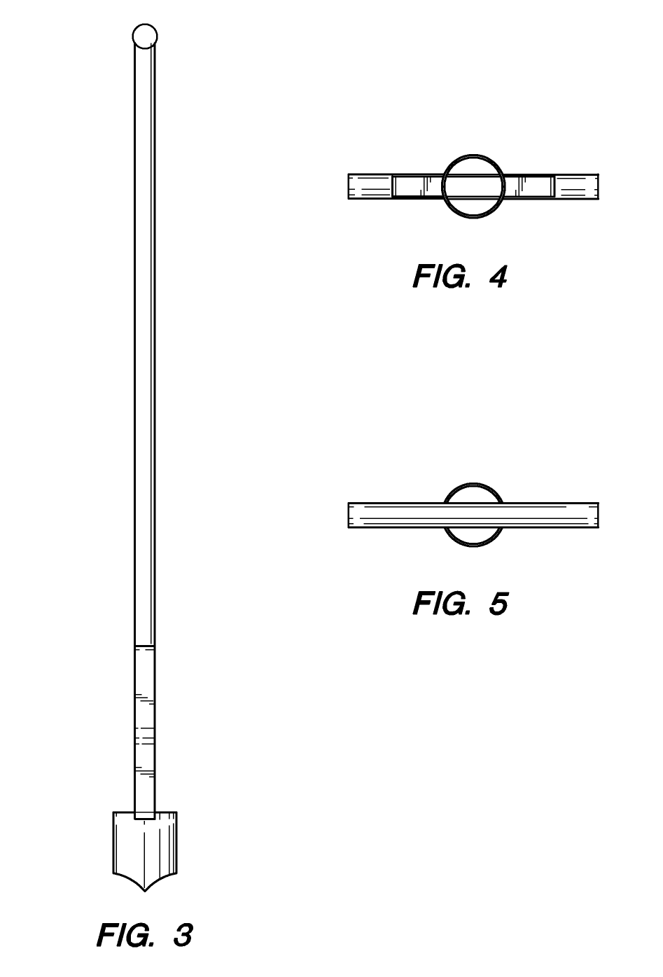

FIG. 3 through FIG. 5 illustrate different views of the sprinkler head trimmer of FIG. 1 and FIG. 2.

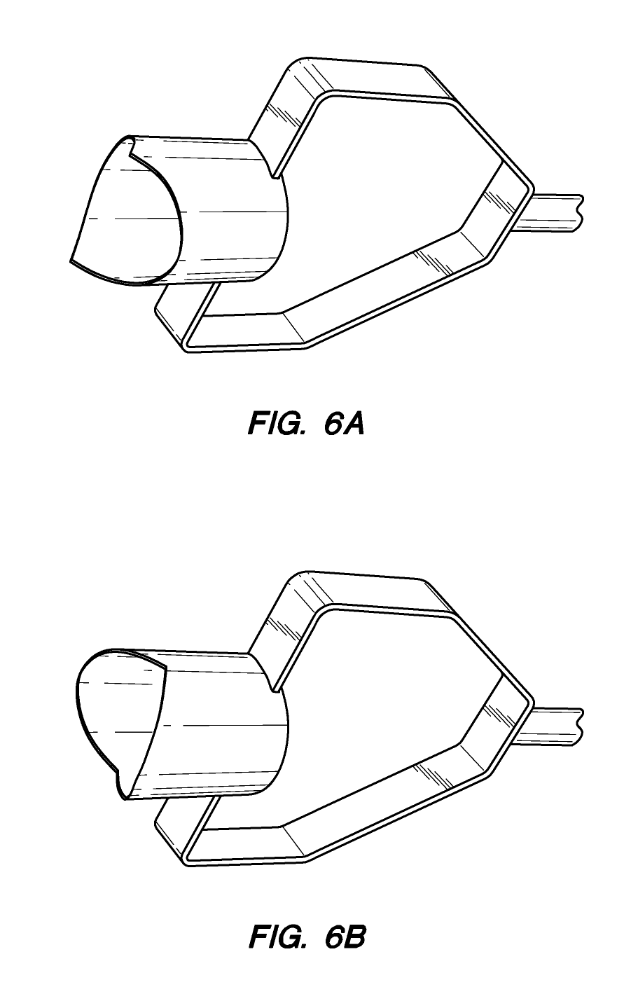

Referring to FIG. 6A and FIG. 6B, two different exemplary configurations of the trimming head are shown. In both examples, the trimming head consists of two opposing blades, wherein each of the two opposing blades consists of two curved edges, the two curved edges meeting at a point of the blade. In FIG. 6A, illustrating the trimming head 1 of FIG. 1, the two curved edges are concave at the point of the blade, forming a cusp. In FIG. 6B, the two curved edges are convex at the point of the blade, forming a scallop. The trimming heads may be formed from sections of thin-wall pipe or tubing, for example. In the case of the trimming head of FIG. 6B especially, twisting or turning of the T handle is rarely if ever needed.

In use, the user locates a sprinkler head, aligns the annular blade member 1 with the sprinkler head, and applies foot pressure to the foot pressure region 3 to cause the annular blade member to surround the sprinkler head. Because the blade configuration presents an unobstructed view, aligning the annular blade member with the sprinkler head may be achieved more readily than with other tools. The cutting action of the annular blade member 1 will typically create a plug of grass, soil, or other debris. The plug may then be removed by hand. The operation takes only a few moments, and the result is a neatly-trimmed area enabling unimpeded operation of the sprinkler head. The precise, neat trimming that results ensures that sprinkler heads are as unobtrusive as possible, allowing the appearance of the lawn itself to be a focal point, without unwanted distractions.

At least two advantages result from the top of the annular blade member 1 being unobstructed. One advantage is that improved visibility makes it easier to achieve proper positioning of the annular blade member above and around the sprinkler head. Another advantage is that the tool can be used during operation of the sprinklers (while wearing rain gear if needed), greatly simplifying location of the sprinkler heads. In this instance, the tool can be used in a first pass with the sprinklers (e.g., pop-up sprinklers) on, without applying foot pressure, and in a second subsequent pass, if needed, with the sprinklers off, applying foot pressure as necessary. In some instances, foot pressure can be applied by first pressing down the sprinkler head with the foot, without harming the sprinkler head.

Proper trimming may be easily maintained by using the trimmer on each sprinkler head periodically, for example monthly. Over-trimming, such as by a line trimmer or blade trimmer or the like, is avoided, as is unsightliness often caused by such over-trimming. Also avoided are various other expedients designed to ensure unimpeded sprinkler head operation that add un-needed effort, expense and maintenance, and that often detract from the aesthetic appearance of a lawn.

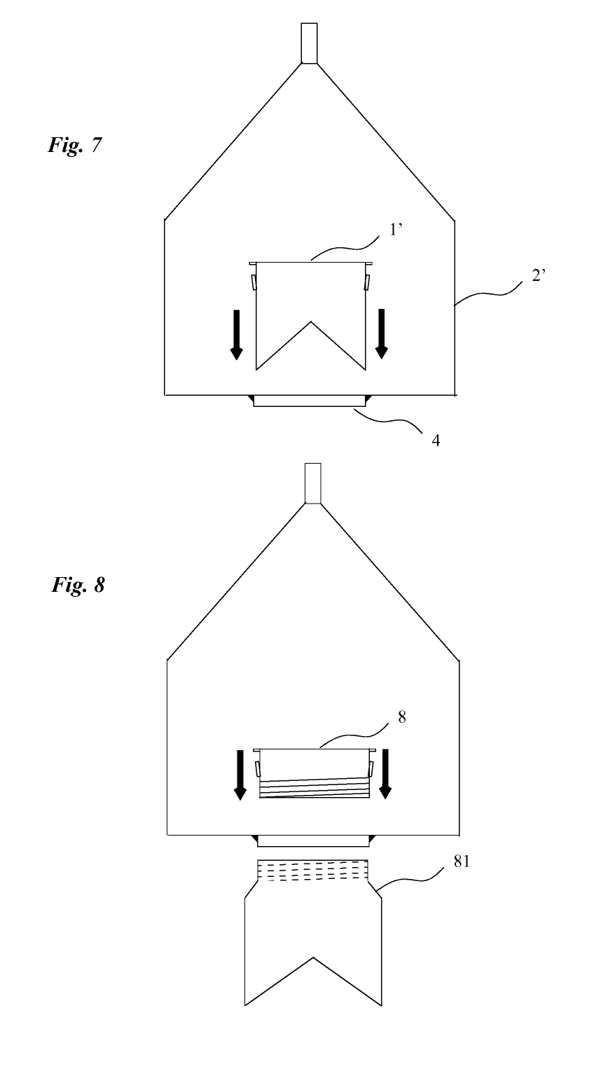

For lawn professionals, all-metal construction of the sprinkler head trimmer will assure many years of trouble-free use. For home owners and non-professionals, a cost-reduced sprinkler trimmer, though it may be somewhat less durable, may be preferable. Referring to FIG. 7, a diagram is shown of another sprinkler head trimmer. The trimming head 1′ is formed of plastic selected for its properties including durability (such as glass-filled nylon) and may be injection molded. The support member 2′ is provided with a short cylindrical member 4. The trimming head 1′ is inserted from above into the cylindrical member so as to snap into place. For example, spring tabs may engage the underside of the cylindrical member 4 in such a way as to allow the trimming head 1′ to be subsequently removed by pressing the spring tabs. The trimming head 1′ may be designed so as to engage the support member 2′ so as to prevent rotation of the trimming head 1′.

The trimming head 1′ may be configured so as to allow it to snap in facing upward instead of downward, for storage and transport. In this configuration, the trimming head 1′ is more protected by the support member 2′ from possible damage.

A number of interchangeable trimming heads or other implements may be provided so as to interoperate with an assembly that includes the T handle 5′ and the support member 2′, with its cylindrical member 4. Different trimming heads may be provided for different types of sprinklers. Other implements may be provided for cultivation, aeration, and other lawn care and yard care tasks.

Referring to FIG. 8, in order to allow for trimming heads or implements of different diameters, a threaded adapter 8 may be provided. The adapter 8 snaps into place (like the trimming head previously described) and is provided with a threaded portion that extends beyond the cylindrical member 4. The adapter 8 may be designed so as to engage the support member 2′ so as to prevent rotation. Any of various trimming heads or implements may then be threaded onto the adapter 8. In the case of trimming heads of different diameter, typically the trimming head will have a transition region in which it transitions from a larger (or smaller) diameter to a diameter that matches that of the adapter 8. One such trimming head 81 is shown in FIG. 8. The adapter 8 and the trimming heads or implements that attach to it may be metal, plastic, or any other suitable material.

In other embodiments, the cylindrical member 4 may itself be threaded, removing the need for an adapter.

In still other embodiments, the trimming head 1 or 1′ and the support member 2 or 2′ may both be plastic and may be molded in one piece that attaches to the T handle 5 or 5′. The molded piece may thread onto the T handle 5 or 5′, for example. In still further embodiments, the T handle 5 or 5′ may also be formed of plastic.

It will be apparent to those of ordinary skill in the art that the present invention can be embodied in other specific forms without departing from the spirit or essential character thereof The foregoing description is therefore to be regarded as illustrative, not restrictive. The scope of the invention is defined by the appended claims, not the foregoing description, and all changes which some within the range of scope of equivalents thereof are intended to be embraced therein.

1.-21. (canceled)

22. A lawn or garden tool comprising
a tee handle
a stirrup member coupled to the tee handle, configured to receive a foot of a user through an opening of the stirrup member; and
a cylindrical member coupled to the stirrup member so as to form a cylindrical opening located along a bottom edge of the stirrup member, the stirrup member providing first and second separated foot support areas at opposite sides of the cylindrical member;
wherein the cylindrical member has a top and bottom and that is open and unobstructed at the top enabling a user to sight through the open and unobstructed top of the cylinder; and
wherein the cutting edge comprises a plurality of scalloped edges.

23. The lawn or garden tool of claim 22, wherein the cylindrical member comprises a cutting edge.

24. (canceled)

25. The lawn or garden tool of claim 24 wherein the cutting edge consists essentially of two scalloped edges.

26. The lawn or garden tool of claim 22, wherein the cylindrical member is formed of metal.

27. The lawn or garden tool of claim 22, wherein the cylindrical member is formed of reinforced plastic.

28. A method of trimming a sprinkler head using a tee-handled tool comprising a cylindrical cutting head haying a top and bottom and that is open and unobstructed at the top for a distance enabling a user to have a clear, unobstructed view through the top of the cylindrical cutting head, comprising:
the user sighting through the open and unobstructed top of the cylinder;
the user situating the cylinder in relation to a sprinkler head; and
the user covering the top of the cylinder with the user's foot and applying downward pressure to the cylinder.
